(19) United States
(12) Patent Application Publication
(10) Pub. No.: US 2024/0235268 A1
(43) Pub. Date: Jul. 11, 2024

(54) Far Field Magnetic Power Transfer

(71) Applicant: Hector Humberto Gomez Acevedo, Mexico City (MX)

(72) Inventor: Hector Humberto Gomez Acevedo, Mexico City (MX)

(21) Appl. No.: 18/538,281

(22) Filed: Dec. 13, 2023

Related U.S. Application Data
(60) Provisional application No. 63/495,295, filed on Apr. 10, 2023.
(60) Provisional application No. 63/387,693, filed on Dec. 15, 2022.

(51) Int. Cl. H02J 50/12; H01F 38/14; H02J 50/00; H02J 50/40; H04B 5/26; H04B 5/79

(52) U.S. Cl. CPC H02J 50/12; H01F 38/14; H02J 50/005; H02J 50/40; H04B 5/263; H04B 5/79; H01F 2038/143; H02J 2310/23

(57) ABSTRACT

A far field magnetic power transfer (FFMPT) system, device, and method that enables safer and farther power transmission through magnetic fields, achieving more useful and greater power transfer distances compared against magnetic induction and radiative power transfer. The FFMPT systems, devices, and methods may be used to deliver power through matter such as wood, walls, and biological material such as a patient's body. The FFMPT systems, devices, and methods can be used for neuronal modulation, endovascular catheter guidance, wireless and radiation free powering of implantable devices, and other uses.

### RELATED APPLICATIONS

This application claims the benefit of U.S. Provisional Application Ser. No. 63/387,693, filed Dec. 15, 2022, titled FAR FIELD MAGNETIC POWER TRANSFER, and U.S. Provisional Application Ser. No. 63/495,295, filed Apr. 10, 2023, titled FAR FIELD MAGNETIC POWER TRANSFER the entire disclosures of which are herein incorporated by reference.

### BACKGROUND

### Technical Field

The present disclosure generally relates to electromagnetic induction. More particularly, but not exclusively, the present disclosure relates to far field magnetic power transfer, reception, and analysis.

### Description of Related Art

Short-range near-field inductive link, wireless power transfer has been present in technology for many decades, mostly on electromagnetic motors.

All of the subject matter discussed in the Background section is not necessarily prior art and should not be assumed to be prior art merely as a result of its discussion in the Background section. Along these lines, any recognition of problems in the prior art discussed in the Background section or associated with such subject matter should not be treated as prior art unless expressly stated to be prior art. Instead, the discussion of any subject matter in the Background section should be treated as part of the inventor's approach to the particular problem, which, in and of itself, may also be inventive.

### BRIEF SUMMARY

The following is a summary of the present disclosure to provide an introductory understanding of some features and context. This summary is not intended to identify key or critical elements of the present disclosure or to delineate the scope of the disclosure. This summary presents certain concepts of the present disclosure in a simplified form as a prelude to the more detailed description that is later presented.

The device, method, and system embodiments described in this disclosure (i.e., the teachings of this disclosure) enable use of far field magnetic power transfer (FFMPT) for a wide variety of applications.

Certain types of short-range, near-field inductive link, wireless power transfer are known. One limitation of inductive power transfer is that inductive the transmitted energy decays on an inverse ratio to the square of the distance. This limitation is a key component of the design of conventional electromagnetic wireless power transfer devices, which are sometimes referred to as electric engines. In these conventional electric engines, power is transferred over a working distance of only few millimeters between magnets (e.g., natural magnets, manmade magnets, electromagnets, or the like).

Another type of wireless power transfer is referred to as radiative transmission. Radiative transmission of power includes emission and reception of a synchronous far-field radio-frequency (RF) signal, which has the advantages of achieving longer distances, but generally requires an accurate alignment of components.

The present inventor has discovered a novel means of far field magnetic power transfer that enables safer power transfer with many advantages over conventional systems. One advantage is power transfer over greater distances than convention inductive power transfer. Another advantage is greater tolerance to misalignment of power transmission and power reception components. This novel technology may be used to deliver magnetic/electromagnetic power not only farther, but also in a safer way because the power transfer does not rely on electromagnetic radiation with its ionizing effect. On the other hand, this novel technology may also be applied on the design of more efficient antennas using electromagnetic radiation with its ionizing effect. The inventor has further discovered that this novel technology allows magnetic energy to pass through solid matter such as wood, walls, biological tissue such as a human body, and other materials. Accordingly, the novel technology enables applications in the biomedical area (e.g., neuronal modulation, endovascular catheter guidance, wireless and radiation free powering of implantable devices, and other medical applications), the consumer electronics area (e.g., speakers, microphones, sensors, user interfaces, light sources, and the like), the industrial area (e.g., electric engines, high-torque machinery, precision machinery, dangerous environment machinery, flammable or explosive environments, and the like), the military area, and still other areas. In other applications, the magnetic field may now be set to cross through different materials in order to determine one or more particular electromagnetic signatures. And in still other areas, the far field magnetic power transfer technology of the present disclosure may be embodied as a magnetic router and a data transmission method to decrease the radial constant exposure produced by near microwave present technologies.

In an embodiment, a Far Field Magnetic Power Transfer System and Method can include a multi magnet of multiple layers array. The Far Field Magnetic Power Transfer System and Method can include multi electromagnet of multiple layers array. The Far Field Magnetic Power Transfer System and Method can include at least two multi electromagnet arrays where each electromagnet receives its own electric current and therefore produces its own magnetic field, being the magnetic forces of the magnetic fields of each paralleled electromagnet with the tendency of being aligned to each other, given that the electromagnets belonging to the same group are built with the same shape but with different size in order to behave as a multi electromagnet of multiple layers array. The magnets can be built on a tubular fashion where such multiple magnets, are connected on parallel. The interaction of such multiple magnetic fields in a given period of time can generate asynchronous as well as synchronous magnetic field. A Resonant Magnetic Field can be produced. Each magnet can be feed independently with variable intensities, voltages and frequencies in order to generate a multivariate multi region magnetic field. The core of the solenoids can include a high magnetic permittivity material such as iron, Permalloy (nickel-iron), Mu-material (Nickel-Iron-Zink) and even vacuum in order to increase magnetic power transfer. Multilayer solenoids arrays can be employed as the substitute of standard solenoids in order to increase its inductive power and inductive length reach and to decrease impedance. The Far Field Power Transfer can be employed for charging of electric devices by placing such devices between at least a couple of multilayer electromagnets array, having such electric device a receiving charging electromagnet and the electronic means to use it. The Far Field Power Transfer can be employed for charging of electric devices by connecting a multilayer electromagnet to the device to be charged in order to directly couple the emitter multiple solenoids array with the multiple solenoids array connected to the device to be charged. The Far Field Magnetic Power transfer method and system can also employed as data transfer technology between the coupled multilayer solenoids arrays by changes on the magnetic field, in order to use such magnetic field intensity variations as binary digital code. The Far Field Magnetic Power transfer is employed as data transfer technology between the multilayer solenoids arrays and a third emitter and receiver multiple solenoids array that is connected to a smart device such as a smart phone, a tablet, an implantable device or a vehicle, in order to receive or emit binary data and as long as such third solenoids array remains on the transmission range of such first and second coupled solenoids array. The Far Field Magnetic Power transfer can be employed as data transfer technology between at least one router connected multilayer solenoids arrays and a third emitter and receiver multiple solenoids array that can be connected to a smart device such as a smart phone, a tablet, an implantable device or a vehicle, in order to directly couple the router with the device and receive or emit binary data and as long as such third solenoids array (device's connected) remains on the transmission range of such first solenoids array. Each emitter solenoid can be feed independently in a synchronized and consecutive fashion wherein the high frequency data can be sequentially divided in small segments and sequentially can be sent to consecutive layers where the other segments not transmitting the data in that particular segment, remain feed with ridge or constant voltage. That means that each individual solenoid can have more time to transduce electric signal into a magnetic field variation. This embodiment allows much more data transmission without high voltage or heavy energy losses. Digital data arrives to the router where binary digits, comprised each by “one” or “zero”, wherein the higher voltage represents the number “one” and lower voltage represents “zero” wherein each sequence can be separated by standard electronic means into single digits that are sequentially sent to the emitter layers respectively by the router in order for each solenoid to turn on and off only once every seven binary digits, lowering energy requirements and heat emission. So, the receiving solenoids array on the receiving devices are now capable to figure out if a “zero” or a “one” was emitted and received through such magnetic field, recovering the exact binary number sequence emitted by the router where interference may be filtered with this novel data transfer magnetic system given that since each binary digit with value “one” was transmitted through a timed specific solenoid layer where the whole magnetic field was affected on a very specific and unique manner every time a “one” passes through such layer. So the verification parameters to clean the transmitted data will not admit “ones” that did not come through the expected emitter layer at such specific particular time.

This Brief Summary has been provided to describe certain concepts in a simplified form that are further described in more detail in the Detailed Description. The Brief Summary does not limit the scope of the claimed subject matter, but rather the words of the claims themselves determine the scope of the claimed subject matter.

### BRIEF DESCRIPTION OF THE SEVERAL VIEWS OF THE DRAWINGS

Non-limiting and non-exhaustive embodiments are described with reference to the following drawings, wherein like labels refer to like parts throughout the various views unless otherwise specified. The sizes and relative positions of elements in the drawings are not necessarily drawn to scale. For example, the shapes of various elements are selected, enlarged, and positioned to improve drawing legibility. The particular shapes of the elements as drawn have been selected for ease of recognition in the drawings. One or more embodiments are described hereinafter with reference to the accompanying drawings in which:

FIG. 1 is an embodiment of a far field magnetic power transfer system and method;

FIG. 2 is an embodiment of power transfer as a power line of reduced impedance;

FIG. 3 is an embodiment of catheter guidance;

FIG. 4 is an embodiment of power transfer into an implantable medical device;

FIG. 5 is an embodiment for sensing an electromagnetic response of what is sensed with a far field magnetic force via a particular transfer equation;

FIG. 6 is an embodiment of specialized working solenoids employing the far field magnetic power transfer system and method;

FIG. 7 is two solenoids transferring magnetic power using far field magnetic power transfer;

FIG. 8 is another embodiment of solenoids adapted as top performance antennas employing far field magnetic power transfer technologies;

FIG. 9 is another embodiment of solenoids adapted as top performance antennas employing the Far-Field Magnetic Power Transfer System;

FIG. 10 shows a preferred embodiment for catheter guidance;

FIG. 11 shows a preferred embodiment for power transfer into an implantable medical device;

FIG. 12 shows a preferred embodiment for sensing the electromagnetic response of what is sensed with the far field magnetic force (transfer equation); and

FIG. 13 is another embodiment of a far field magnetic power transfer (FFMPT) system and method.

### DETAILED DESCRIPTION

The present disclosure may be understood more readily by reference to this detailed description and the accompanying figures. The terminology used herein is for the purpose of describing specific embodiments only and is not limiting to the claims unless a court or accepted body of competent jurisdiction determines that such terminology is limiting. Unless specifically defined in the present disclosure, the terminology used herein is to be given its traditional meaning as known in the relevant art.

In the following description, certain specific details are set forth in order to provide a thorough understanding of various disclosed embodiments. However, one skilled in the relevant art will recognize that embodiments may be practiced without one or more of these specific details, or with other methods, components, materials, and the like. In other instances, certain structures associated with far field magnetic power transfer (FFMPT) such as computing devices, control systems, wired and wireless communications protocols, wired and wireless transceivers, radios, communications ports, user interface devices and certain algorithms have not been shown or described in detail to avoid unnecessarily obscuring more detailed descriptions of the embodiments.

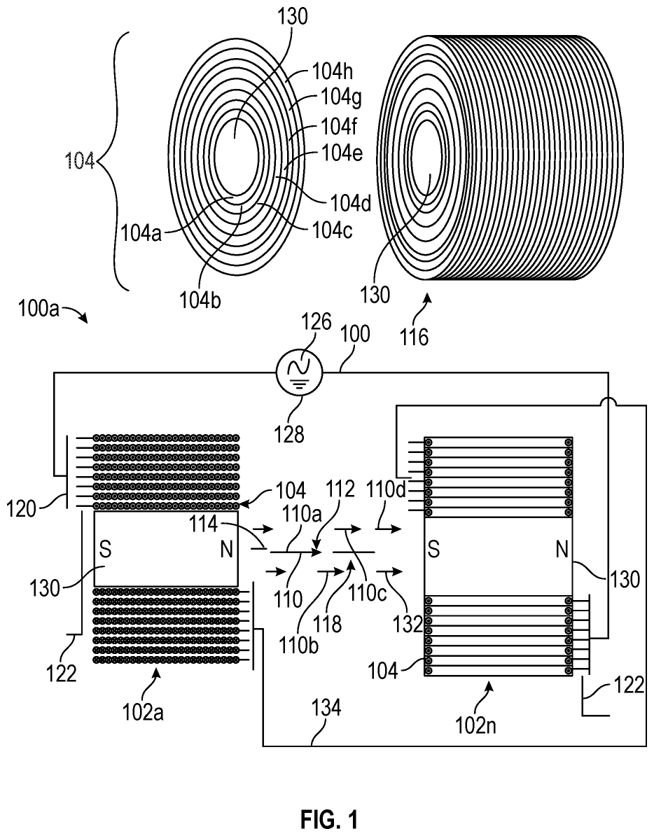

FIG. 1 is an embodiment of a far field magnetic power transfer (FFMPT) system and method 100a. The embodiment illustrates one system 100 that enables operation far field magnetic power transfer, but other systems are also contemplated.

The FFMPT embodiment 100 includes two or more multi electromagnet arrays 102a, 102n wherein each electromagnet 104a-104h, when in operation, produces its own magnetic field 106. In the FFMPT embodiment 100, magnetic forces of the magnetic fields of each electromagnet 104 are cooperatively aligned at least in part because each electromagnet 104 is built with a same or substantially similar shape and a different size, and such arrangement permits the array 102 to behave as a multi electromagnet of multiple layers array. Stated differently, the FFMPT embodiment 100 of FIG. 1 includes any suitable number of at least two magnets 104a-104h, where each magnet 104a-104h produces a magnetic field 106, and where the elevated magnetic density region of magnetic force lines 108 produces a vector 110a-110f on each of such magnets and where each vector 110a, 110n of each magnet tends to be oriented and aligned on a trajectory 112 and direction with the resultant vector 110 comprised by the multiple magnetic force vector lines produced by such magnets 106.

In the embodiments discussed in the present disclosure, far field magnetic power transfer (FFMPT) is enhanced by the use of multiple electromagnets 104 aligned on the same trajectory 112, which in at least one embodiment has a straight or otherwise linear shape 114.

In some cases, the electromagnets 104a, 104n are built in a generally tubular (e.g., cylindrical, cylindrical with a circular, ovular, square, rectangular, triangular, hexagonal, octagonal, or some other cross section) fashion wherein such multiple electromagnets 104, in the case of being solenoids 116 or solenoid-like components, are electrically, physically, or electrically and physically coupled in parallel 120. Such multiple electromagnets 104 may be formed in at least one of two or more groups (e.g., parallel to each other, aligned to a same axis 118, or formed or otherwise arranged in some other way).

In the embodiment of FIG. 1, the tubular solenoids 116 are concentrically positioned along their tubular axis 118. Each solenoid 116 is electrically connected, in at least one embodiment, in parallel 120 with the other solenoids 116 of the same group. In other embodiments, one or more solenoids 116 are connected to one or more other independent electric signal feeding sources 122. In still other embodiments, each solenoid 116 group may have its own separate electrical current source. By having multiple magnets 104 on each group, the interaction of the associated multiple magnetic fields 106 in a given period of time generates asynchronous, synchronous, or asynchronous and synchronous magnetic field interactions, and wherein, consequently, magnetic synchronous or asynchronous fields are created. Of course, on such array of tubular solenoids 116, using the resonant frequencies of such multiple interacting magnetic fields, a resonant magnetic field (RMF) 124 may be produced.

The use of resonant magnetic fields 124 as an FFMPT tool is also a novel application of the teaching of the present disclosure. In some embodiments, FFMPT is desirably achieved with the use of alternating current (AC) 126 to feed such aligned electromagnets 104. Other sources of electrical power include direct current, varying current, and other electrical source signals that produce desirable magnetic fields 106.

The present inventor has discovered that FFMPT can occur even with the use of direct current (DC) 128 and two or more multiple aligned multicoil arrays, however the use of alternate current with similar frequencies has been shown to increase the power transfer as in conventional radiative power transfer but with the difference that instead of radio frequency waves or microwaves, the power transfer is made with magnetic power. Lesser magnetic power transmission can occur in some cases when different frequencies (e.g., non-multiple frequencies) are employed between first and second groups of solenoids.

Selection of a suitable solenoid core 130 may further affect how much energy is transferred during FFMPT. Depending on design preferences, for example, it is desirable that the solenoid's core 130 has a very high magnetic conductivity, which can increase the inductance. Along these lines, ferromagnetic materials, paramagnetic materials, or some other type of material that is susceptible to becoming magnetized in the presence of a magnetic field that is generated when current is passed through a coil wound around the core can be desirable. In at least one embodiment, a core 130 is made of iron. In other embodiments, and in order to increase magnetic permeability, a core 130 may be formed of a permalloy (e.g., nickel-iron) and deployed in the in one or more electromagnets 104 of the present disclosure. In other words, at least one embodiment 100a of far field magnetic power transfer (FFMPT) taught in the present disclosure is achieved by employing any number of separated groups 102a, 102n of generally tubular shaped electromagnets 104 (i.e., solenoids 116) that align the output trajectory 112 of a first group 102a of solenoids 116 with the input trajectory on aim to the core 130 of a second group 102n in coincidence with the vector 110 resultant of the magnetic force lines of the magnetic fields involved in each tubular concentric array of solenoids composing such group 102.

One of skill in the art will recognize that this cooperative effect to increase magnetic strength may also be elicited by employing a three, four, or any suitable number of groups 102 of electromagnets 104 as if in a transmission line. In such cases, a long bundle of magnetic force lines 132 traveling between the north pole of one of the groups 102a and the south pole of another proximate group 102n as if on each group 102 there were a dipole of a much bigger (e.g., stronger) magnet. Hence, the teaching of the present disclosure includes devices, methods, and systems that, as a consequence, permit magnetic power transmission at larger (e.g., bigger, longer, deeper, penetrating, and the like) distances since such transmission takes place through a higher or highest magnetic density pathway between the dipoles of an electromagnet 104. One of skill in the art will further recognize that this novel capability allows the projection of much longer and better delimited regions with highest magnetic density, shaped as a main bundle of the magnetic force lines. Accordingly, the higher or highest magnetic density power vector may be arranged to cross through materials with magnetic permeability, such as air, paper, wood, biological material (e.g., the human body) or any other such material by simply locating the material of interest (e.g., a region or regions of a human body) between a first group of electromagnets 102 and second group of electromagnets 102, thereby enabling novel magnetic power transfer through the material of interest (e.g., human tissues).

Via the teaching of the present disclosure, multiple applications that require safer and narrower power pathway delimitation are now possible. What's more, other applications of the inventive subject matter such as electric charging of electric devices (e.g., smart phones, electric cars, and any other device) is now possible by placing power receptors of the system or device, or placing the material of interest between the groups 102a, 102n of the FFMPT system.

The FFMPT embodiment 100 of FIG. 1 includes an emitter formed of multiple electromagnets 104 arranged as an array 102 capable of achieving enhanced far-field magnetic power transfer to a receiver formed of multiple electromagnets 104 arranged as array 102 by making the source impedance, the emitter electromagnet impedance, the receiver electromagnet impedance, and load impedance substantially equal. Additionally, in at least some cases, the impedance of the electromagnets 104 is lowered, in some cases as much as possible, by known parallel electrical ways to connect electromagnets 104. So, in order to decrease such impedance, a multiple parallel array 102 of coils is performed, substituting the emitter and the receiver of separate and distinct electromagnets 104 by parallel connected arrays 102 of multiple coils on both cases (i.e., emitter and receiver). In the embodiment of FIG. 1, the groups (i.e., arrays) 102 of multiple electromagnets 104 are formed by generally tubular shaped electromagnets 104a-104n having incremental diameters to fit as shown in at least one case in FIG. 1.

Despite radiative power transference, the disclosed technology is now capable of performing far field magnetic power transfer between at least two electromagnet arrays even if direct current (DC) or half wave rectified current is employed. Although each array can be independently electrically sourced, in at least some embodiments an emitter electromagnets array 102a is electrically coupled in a serial 134 array with the receiver electromagnets array 102n.

In the embodiment of FIG. 1, magnetic power transfer is improved when the cores 116 of the multiple electromagnet arrays 102 have force lines 132 with a common axial trajectory and direction (e.g., vector 110). With such alignment, magnetic power can now be forced across much higher distances between an emitter electromagnetic array 102a and a receiver electromagnetic array 102n even when such arrays 102 are serially electrically coupled 134.

The FFMPT embodiment 100 of FIG. 1 permits new and advantageous applications that were previously unavailable with conventional technologies. For example, the teaching of the present disclosure enables the placement of matter, such as a person or other biological body or body part, between arrays 102 of the type described herein to apply magnetic power transfer for multiple purposes such as the charging of an electrical medical implant, the more accurate guidance of a medical device in a patient's body (e.g., an endovascular medical device, an endo-luminal medical catheter, or some other medical device), or even for therapeutic use. What's more, the power transfer of the technology disclosed herein may be enhanced if the emitter electromagnet and the receiver electromagnet are sourced with one or more alternating current (AC) signals having desirably selected properties (e.g., frequency, amplitude, waveform, voltage, current, phase, and the like). In one or more of these cases, resonant magnetic fields with alternate directions may also be enhanced.

In some cases, an alternating current is filtered to allow only positive or only negative electric signals. In these cases, the magnetic field becomes variable and unidirectional, accordingly to the variability of the required application. Nevertheless, one of skill in the art will recognize that the power transfer is still mainly magnetic, safe, and novel. This power transfer is different from magnetic induction or electromagnetic radiance. One advantage compared with magnetic induction is that now power transfer becomes a far field magnetic power transfer (FFMPT) that does not decay in quadratic fashion with distance. Other advantages overcome one or more disadvantages pf radiance, which requires careful placement, a usable maximum reach of about 30 centimeters, and that power transfer by radiance is made with high radio frequencies or microwave frequencies, which are less safe than magnetic field power transfer.

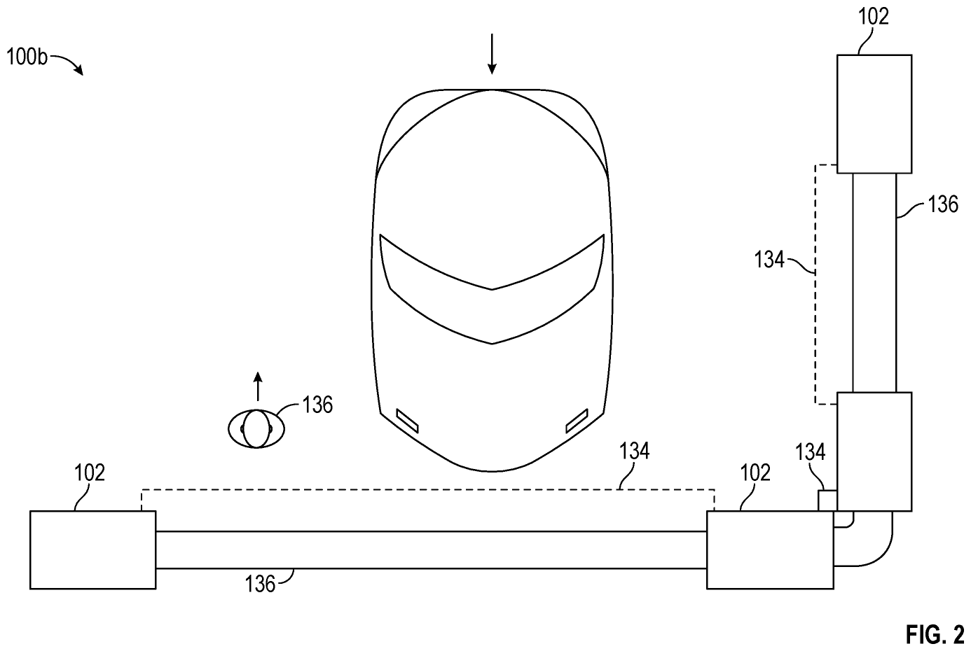

FIG. 2 is an embodiment of far field magnetic power transfer (FFMPT) as a power line of reduced impedance that also works as a movement sensor with a longer reach 100b. The embodiment of FIG. 2 shows a far field magnetic power transfer system and method that includes multiple groups 102 of aligned solenoids 116 working as a power transmission line with a low inductance to resistance ratio. This kind of array system with its multiple arrays 102, besides working as a transmission line, also works as a perimeter motion sensor 136 that can be used over long distances where low intensity with high impedance is preferred. In the embodiment of FIG. 2, the electromagnetic arrays 102 are connected in serial 134, but other arrangements are also contemplated.

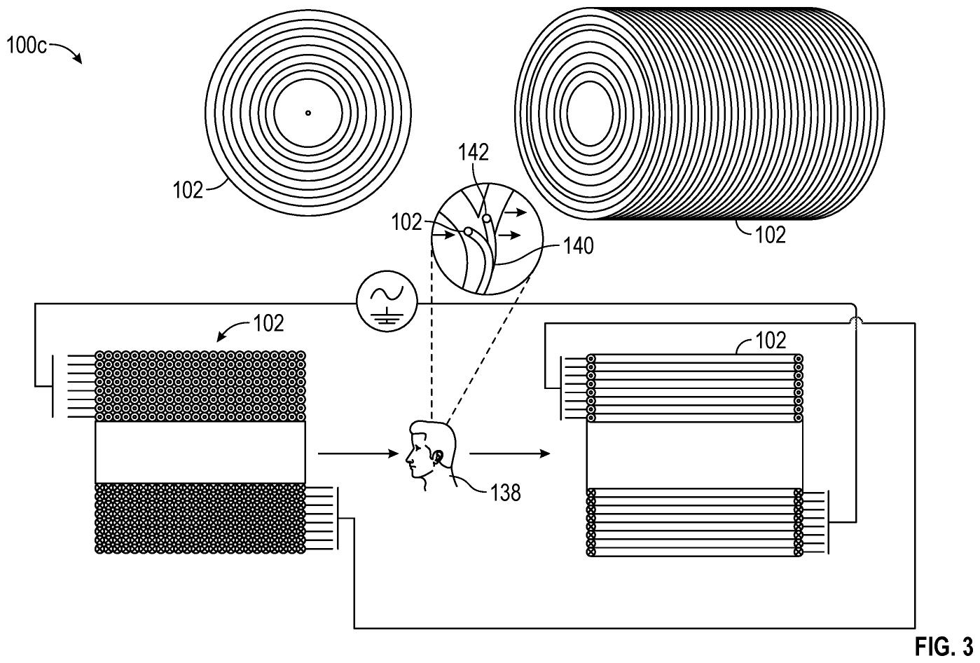

FIG. 3 is an embodiment of catheter guidance 100c. FIG. 3 shows another far field magnetic power transfer (FFMPT) system and method that includes at least two of electromagnetic arrays 102 having solenoids 116 of the types described herein. Between such solenoids 116, a patient 138 (e.g., a human being, a non-human mammal, or some other animal) will have an endovascular or endoluminal catheter 140 advanced for therapeutic action. Sometimes, given the tortuosity of the patient's internal ducts, catheters cannot be bent enough or even accurately guided in the right direction to take a desired bifurcation, and regardless of a medical practitioner's best efforts, such catheters 140 cannot reach the planned target. Such a circumstance produces the impossibility, for instance, of properly treating a cerebral aneurysm and avoiding a stroke or of placing a stent on a coronary artery in order to avoid a myocardial infarction.

In at least one embodiment, an FFMPT system 100 using the devices and methods described herein create a magnetic field that crosses through the body of the patient 138 in a desired direction 110. The system 100 produces an alignment of the tip of the catheter 140 in the desired direction 110, which advancement or other placement of the catheter 140.

One of skill in the art will recognize that although magnetic fields have sometimes been employed to align catheters, no known conventional devices or techniques permit placement that is so deep and directionally controllable as with the systems, devices, and methods of the present disclosure.

In the embodiment 100c of FIG. 3, the tip of the catheter 140 may be formed with any suitable diamagnetic or paramagnetic material 142 that allows the interaction of such catheter 140 with the far field magnetic force, thereby allowing the aiming of the tip of the catheter 140 in the right direction. One of skill in the art will further recognize that he teaching of the present disclosure may also be employed to move energy or devices through the body of a patient 138, paramagnetic and diamagnetic materials, as for instance pharmacological compounds and cells containing such materials.

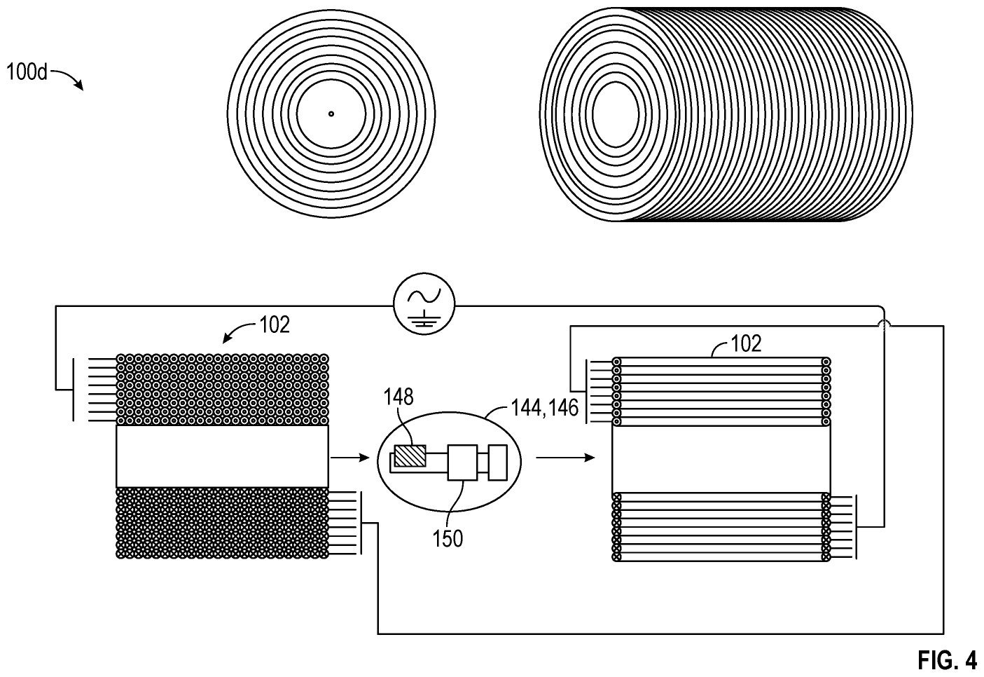

FIG. 4 is an embodiment of power transfer into an implantable medical device 100d. FIG. 4 shows a far field magnetic power transfer (FFMPT) system 100 deployed with devices and methods described herein to transfer power to an electric circuit 144 without physically contacting or otherwise touching the electric circuit 144. Since this system 100 may therefore send energy through matter, the embodiment of the electric circuit 144 may be presented as an implanted electric device 146.

In the embodiment of the FIG. 4, the implanted electric device 146 is located between two or more electromagnetic arrays 102. One of skill in the art will recognized that there are multiple ways to receive power from a magnetic source. In the embodiment of FIG. 4, and without limiting the scope of this presented technology, a receiver solenoid 148 is placed between two electromagnetic arrays 102 of a type described herein to magnetically transfer power to a power source (e.g., a battery, a capacitor, or some other energy storage device).

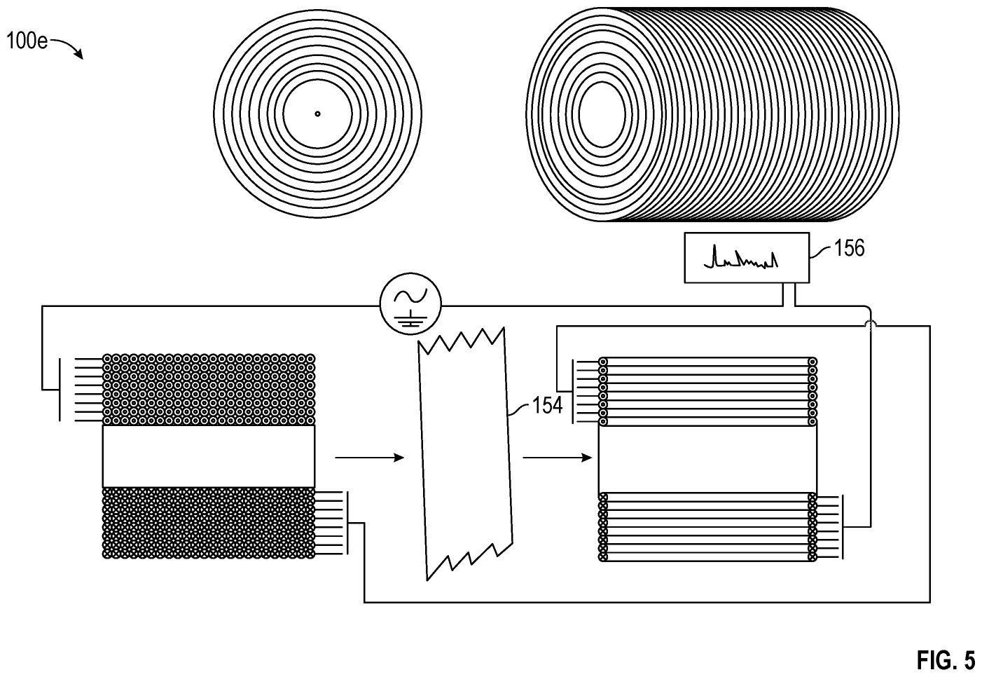

FIG. 5 is an embodiment for sensing an electromagnetic response of what is sensed with a far field magnetic force via a particular transfer equation 100e. FIG. 5 shows a far field magnetic power transfer (FFMPT) system 100 deployed with devices and methods described herein employed to obtain information from the space contained between two or more electromagnetic arrays 102. One exemplary use case includes deeper and more extensive mineral prospecting wherein two or more electromagnetic arrays 102 are placed in an angled position 152. In application of such case, industrial monitoring of diamagnetic and paramagnetic mineral contents dissolved and running through a pipe 154 may be detected and analyzed 156 with the advantage of farther reach and more accuracy provided. In the embodiment, the magnetic field passing through the pipe 154 is altered by the paramagnetic or diamagnetic material as well as by different types of minerals. Such fluctuation detected electronically by the multi electromagnetic arrays 102 and communicated to a computer, a console, a speaker, or some other computationally or human accessible device. One of skill in the art will recognize that the teaching of the present disclosure may be used for the study of electronic devices with the addition of intensity, voltage, frequency, waveform, and other desirable signal processing for better results.

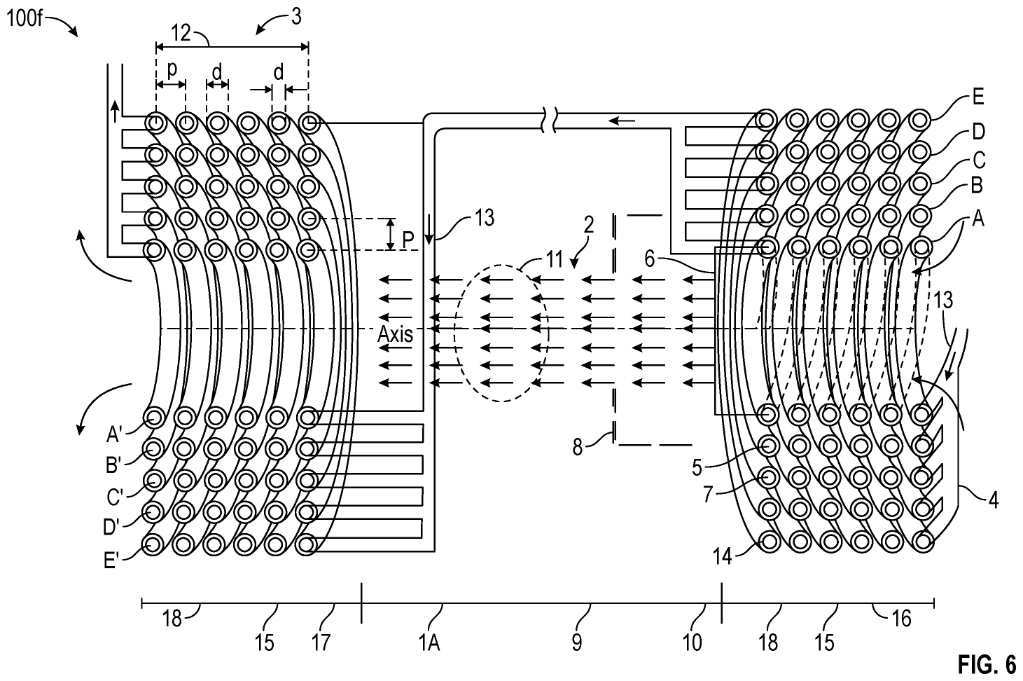

FIG. 6 is another embodiment of a far field magnetic power transfer (FFMPT) system and method 100f. FIG. 6 illustrates specialized working solenoids employing the FFMPT system and method.

FIG. 6 shows an embodiment of at least one FFMPT mechanism 1A that enables FFMPT system and method structures, means, and acts. One aspect of this embodiment is related to energy transfer efficiency, and another aspect is related to its capability to transfer magnetic power 2 on short, middle, and even far distances even with direct current, founding the related physics of this method based on a combination of novel and known electromagnetic phenomena compared with Resonant Inductive Coupling. Besides, special features related to the solenoids 3 are also included on this novel technology, which further separates this method from said Resonant Inductive Coupling independently of the type of feeding circuit 4. In general terms the FFMPT mechanism 1A is comprised by at least one first coil's loop layer 5 that conforms the smallest diameter of a multiple tubular shaped solenoids 6 array arranged on a concentric shape as shown in FIG. 6. In this embodiment, but not every embodiment, there are at least two solenoids 6 where such second solenoid 6 conforms at least a second loop layer 7 conformed by at least one consecutive tubular shaped solenoid 8 where there are multiple tubular shaped consecutive, incremental diameter solenoids 8 comprised by wire loops that runs in a space trajectory 9 as substantially parallel 10 to the first solenoid's loops 5 and so on, creating multiple loop layers A, B, C, D, E with incremental tubular diameters. The electric power feeding of each of the multiple layers 5 is made in parallel. It produces a resonant magnetic field and low impedance on such multilayered solenoids array. The multiple substantially parallel loop 10 trajectories produce a magnetic field with a resultant vector 11. The resultant magnetic vector 11 generally increases according to the number of wire loops on each multilayer solenoid array, the length of the solenoid 12, the number of layered solenoids, and the direction 13 of the electric current on each solenoid 6, 8. At high frequencies, the low impedance of this embodiment prevents relatively high power loss from the emitter solenoid. According to one intended use, the multiple solenoids array may have a common core, multiple cores, or an air core. One of skill in the art will recognize that the FFMPT mechanism 1A of FIG. 6 proposes multiple parallel electrically connected electromagnets 6, 8, where such electromagnets comprise parallel spatial trajectory 10 on their wires 14 with regard the proximal layers of such multilayer solenoids array 15.

In the embodiment of FIG. 6, the FFMPT mechanism 1A includes a first, usually the emitter, multiple solenoids array 16, and a second, usually the receiver, multiple solenoids array 17 known as multiple tubular shaped solenoids 18 regardless first 16 or second 17 position where for clarity, both of such arrays 17, 18 are shown on a cross-sectional, longitudinal, projection manner. One of skill in the art will recognize that all the wires 14 present semi parallel 10 space trajectories 9 with respect their adjacent layered tubular solenoids 18. In this case, a tubular shape of multiple loop layers A, B, C, D, E array 15 configuration is shown, where the solenoid 12 with the smallest diameter A is covered with a second solenoid B having a larger diameter and a third solenoid C on a third layer that has loops with larger diameters than the first and second such solenoids. Of course, multiple loop layers 7 of substantially parallel loops 10 may conform each tubular solenoid 18, increasing its thickness 19. As mentioned, one loop thick layer 5 tubular solenoids 6, 8 in array with a multiple one loop thick layer 7 solenoid is better to decrease impedance of such multiple tubular solenoids array 18. As shown in FIG. 6 multiple solenoid layers A, B, C, D, E may include a substantially parallel multilayer array 15 where each solenoid may contain multiple wire 14 layers of their own. For clarity, only one wire thickness layer is presented in FIG. 6. In other embodiments, multiple substantially parallel layers that are electrically connected in parallel mode, which accumulate the magnetic fields of each substantially parallel wiring and concurrently, such multiple parallel electrical connections provide substantially lower impedance. This embodiment provides the FFMPT mechanism 1A with a multi parallel coil array 15, capable to generate a larger magnetic field than a standard wire length and gauge electromagnet. Such multi coil with substantially parallel multilayer winding array 15 may include diverse multilayer shapes, such as a multi-toroid multilayer or multi-circular or multi-tubular shaped embodiments. One of skill in the art will recognize that the embodiment of FIG. 6 works with direct, ridge, or alternate current indistinctly and therefore the FFMPT mechanism 1A is not dependent of the working principle of Resonant Inductive Coupling. FIG. 6 further illustrates two of such multilayer solenoid arrays 15 located at some distance between each other and the longitudinal axis of both multilayer solenoid arrays 15 are substantially aligned to each other. As shown in FIG. 6, each of the solenoids 6, 8 of the emitter array 16 is fed by the same electric source in a parallel electric mode connection. In other embodiments, however, each solenoid may be electrically fed by different types of electric signals to produce a multi-fluctuating magnetic field made of evanescent waves. FIG. 6 shows the receiver multicoil array 17 receiving a magnetic power transfer.

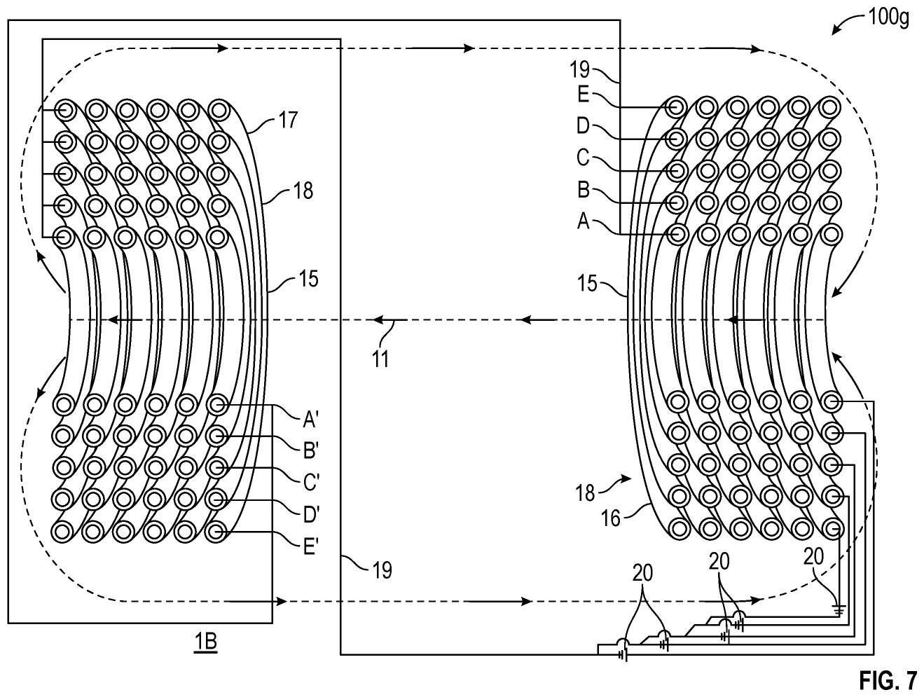

FIG. 7 is another embodiment of a far field magnetic power transfer (FFMPT) system and method 100g. In FIG. 7, the FFMPT mechanism 1B includes two solenoids that are capable of transferring magnetic power using far field magnetic power transfer.

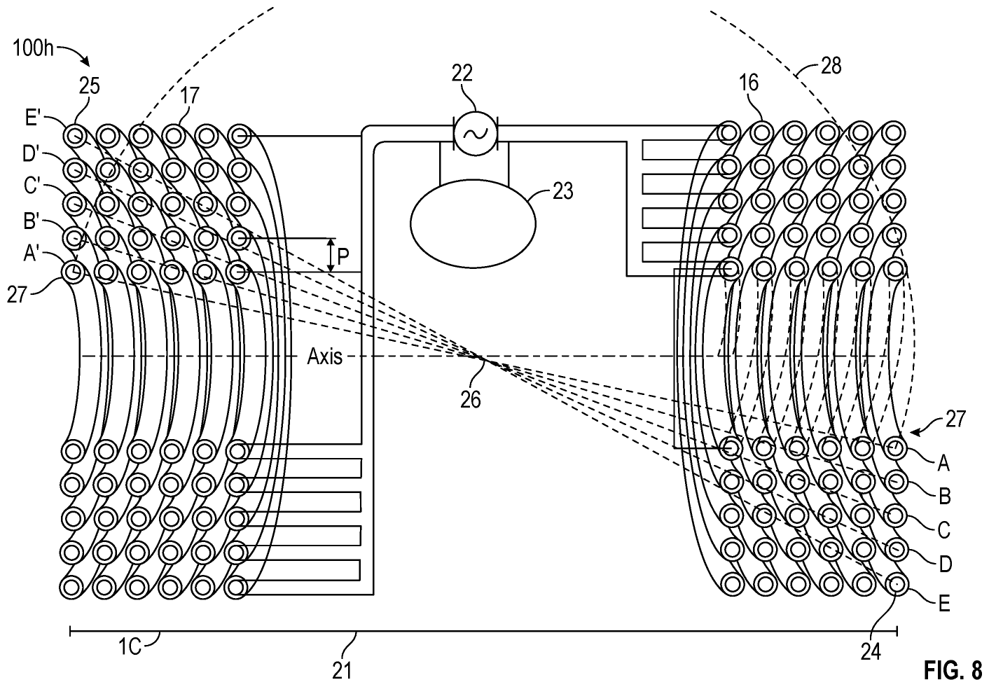

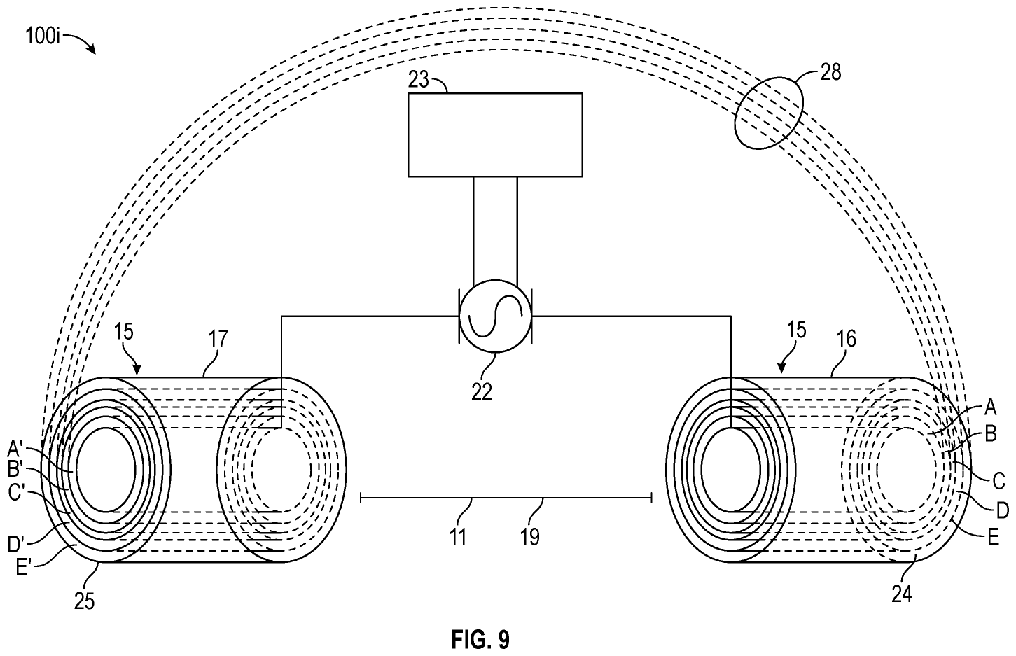

In the embodiment of FIG. 7, a plurality 16, 17 of tubular multi coil, multilayer, substantially parallel winding arrays 15 are also separated from each other and aligned along a longitudinal axis 19. In this case, in order to further optimize magnetic power transfer from the emitter array 16 to the receiving array 17, those two solenoid arrays 18 are electrically coupled 19 optionally in serial or in parallel to be provided with a same frequency and electrical signal. One of skill in the art will recognize that, as in the FFMPT mechanism 1A of FIG. 6, each tubular solenoid from each layer from the emitter array 16 may in some embodiments be independently coupled to each same layer (e.g., A to A′, B to B′, C to C′, D to D′, E to E′) of the tubular solenoid receiver array 17. However, multiple variations accordingly to resonant applications of the magnetic field to be designed may preclude different electric connections from the solenoids from array 16 into the solenoids from array 17 without losing the scope and reach of this teaching. One of skill in the art will recognize that, although electrical power is transferred through the electric connection 19, magnetic power transfer is happening between the emitter array 16 and the receiver array 17 through the magnetic field 11. Of course, emitter 16 and receiver 17 arrays may also be feed independently from different power sources 20 (e.g., alternating current, direct current, variable frequency current, pulsed current, specifically designed waveform, or some other source), but in order to achieve acceptably optimal results in at least some embodiments, the same electromagnetic frequency should be employed. Given that the FFMPT mechanism of FIG. 7 also works with direct current, the action may be explained by multiple magnetic fields concurrently induced on each tubular solenoid 8 where their substantially parallel configuration 10 enhances the formation of a synchronous resonant magnetic field 11. Given that a second synchronous resonant magnetic field is also formed in the receiving array 17, and given that the magnetic resultant vectors are on the same axis 11 and direction, an acceptably optimized middle to far field magnetic power transfer system and method occurs thereby generating with this novel combination of structures and structural arrangements a true novel technology for FFMPT. One of skill in the art will recognize that any mechanism with the means to receive such magnetic energy may now be located between such emitter 16 and receiver 17 arrays where such alignment between arrays 16, 17 works as a conduit to better lead the magnetic power transfer along the axis 11. One of skill in the art will further recognize that such embodiment may be useful if any object such as a plant, a body part, or an electronic wireless chargeable device is planned to receive such magnetic power transfer. Hence, the FFMPT mechanisms of both FIGS. 6 and 7 include at least two multi electromagnet arrays 2, wherein each electromagnet 3 produces its own magnetic field, being the magnetic forces of the magnetic fields of each magnet aligned to each other given that the electromagnets are built with the same shape but with different size in order to behave as a multi electromagnet of multiple layers array 4. Stated more simply, the embodiment of FIG. 7 includes at least two magnets 3, wherein each magnet produces a magnetic field, wherein the highest magnetic density region of magnetic force lines produces a main magnetic vector field 11 on each of such magnets, and where each vector of each magnet tends to be oriented and aligned on trajectory and direction with the resultant vector 11, which in FIGS. 6 and 7 is represented as multiple magnetic force vector lines produced by such magnets. In the FFMPT embodiments, FFMPT is enhanced by the use of multiple magnets 15 being aligned, for acceptably optimal power transfer, on the same axis 19), being such trajectory, as shown in the embodiments of FIGS. 6, 7, of a straight linear shape 9. In at least one embodiment, magnets 8 are built in a tubular fashion where such plurality of magnets 15, in the embodiments of solenoids shown in FIGS. 8, 9, are electrically connected in parallel.

FIGS. 8 and 9 are other embodiments of far field magnetic power transfer (FFMPT) system and methods 100h, 100i, respectively. In the embodiments, the FFMPT mechanisms 1C, 1D, respectively, include solenoids adapted as top performance antennas that employ far field magnetic power transfer technologies. In at least some cases, the mechanisms 1C, 1D of FIGS. 8 and 9 are a same mechanism.

In FIGS. 8 and 9, tubular multi coil 8, multilayer, substantially parallel winding arrays 15 are employed as antennas 21. One of skill in the art will recognize that the array 16 and 17 now uses the multilayer solenoid arrays 15 as dipolar antennas 21 by concurrently coupling an emitter 22/receiver 23 circuit to both arrays 16, 17 where a voltage difference is now created between the end 24 of each solenoid A, B, C, D, E on array 16 with respect to the ends 25 of each solenoid A′, B′, C′, D′, E′ on array 17. One of skill in the art will recognize that the lines 26 between wire ends 24, 25 on each tubular solenoid A-A′, B-B′, C-C′, D-D′, E-E′ provide a linear reference point of where the electromagnetic waves are expected to appear once emitted or expectedly received. Said lines 26 are on close proximity intersect each other in some embodiments. Hence, this mechanism produces an electromagnetic wave on each alternating voltage cycle between each paired by diameter solenoid (i.e., A-A′, B-B′, C-C′, D-D′, E-E′) arrays 15. One advantage of this arrangement is a low impedance on each array 15 and a high gain antenna since a bipolar pulse 27 is passed through each solenoid end A-A′, B-B′, C-C′, D-D′, E-E′ between both arrays 16, 17. By doing so, same frequency and multiple emission bipolar ends A-A′, B-B′, C-C′, D-D′, E-E′, embodied by the lateral ends of each solenoid 8, where each end is in close proximity of the other ends of the same array 15. Under this scheme, simultaneous or otherwise concurrent waves 28 may now be emitted with variable polarity and multiple emitters producing a complex wave 29, as resultant. One of skill in the art will recognize that many combinations may be achieved by employing as an emitter antenna 21 such multilayer A-A′, B-B′, C-C′, D-D′, E-E′ substantially parallel 10 wire's 14 spatial trajectory arrays 15 by sending on each layer changes on harmonic frequencies and on amplitude. One of skill in the art will further recognize that the solenoid arrays 16, 17 may also change their orientation and distance between such paired solenoid arrays 16, 17 as well as between individual wire ends 24, 25 with respect to ends of the same array 15. Given that the electromagnetic waves 28 are, in some embodiments, concurrently produced and are aligned on substantially the same direction and have the substantially same length, desired electromagnetic features on the emitted electromagnetic energy may be also achieved with respect to amplitude, signal shape, radar signature bounce, and data transmission as well as fast Fourier de-encryption resistance, on such electromagnetic wave is achieved. To further demonstrate this teaching, in at least some embodiments, in order to maximize such characteristics, such farther ends 24, 25 of the solenoids are designed on variable proximity and the length of the wire from the voltage source 22 or receiving circuit 23 to each solenoid end A-A′, B-B′, C-C′, D-D′, E-E′ is substantially the same. One advantage of the present embodiments is that receiver antennas have substantially increased reception. Another advantage these embodiments is that as emitter and receiving antenna 21, the direction of the signal may be manipulated. The acceptably optimal reception alignment is expected to pin point the source along the longitudinal axis that runs between first 16 and second 17 solenoids arrays. As yet one more advantage, the emitted or receiving frequency may be selected by encoded variation of the axial 11 distance between the farther solenoid ends A-A′, B-B′, C-C′, D-D′, E-E′ amongst the first 16 and second 17 arrays.

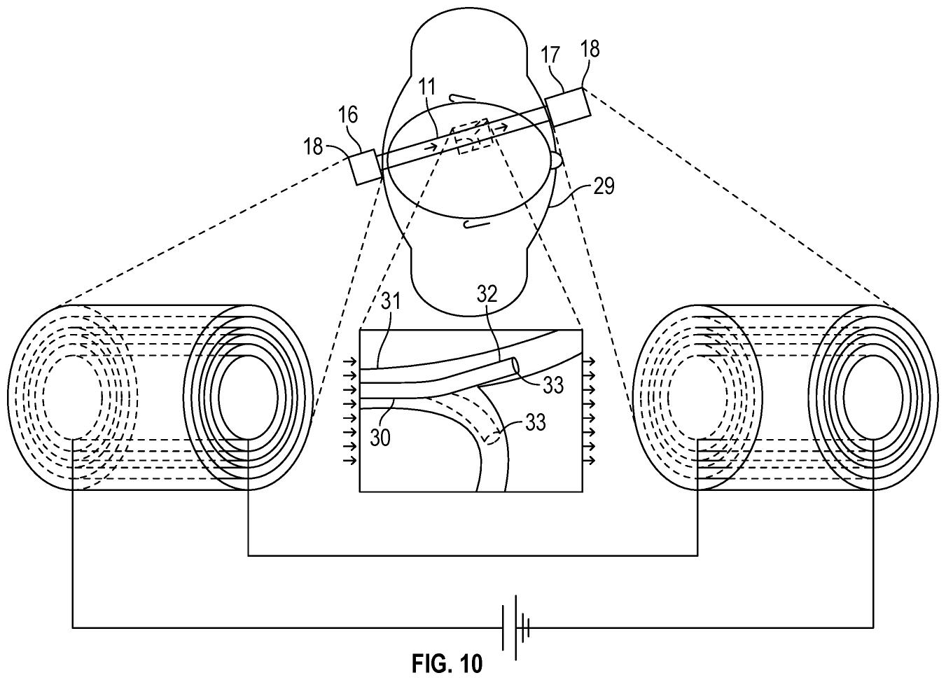

FIG. 10 is another embodiment of a far field magnetic power transfer (FFMPT) system and method 100j. FIG. 10 shows an embodiment for catheter guidance.

The FFMPT mechanism of FIG. 10 includes multiple arrays 15 of aligned solenoids in order to work as a power transmission line with a low inductance to resistance ratio. This kind of array 2, besides of working as a transmission line, may also be employed as a higher reach movement sensor system that may be used, for example, for enhanced magnetic detection on metal detector systems employed on security and prospecting.

The embodiment of FIG. 10 includes at least a pair of coupled solenoid arrays 18 wherein between such solenoids is located a patient 29 wherein an endovascular or endoluminal catheter 30 is being advanced through a vessel or other vascular conduit 31 for therapeutic action. Sometimes, given the tortuosity of the body's ducts, catheters cannot be bent enough or even accurately directed on the right direction in order to take the desired bifurcation, and regardless of the medical practitioner's best efforts, catheters cannot directed to the planned target. That situation produces the medical impossibility, for instance, of properly treating a cerebral aneurysm and avoiding a stroke or placing a stent on a coronary artery to avoid a myocardial infarct. So, in some embodiments, the FFMPT systems and methods of the present disclosure create a magnetic field that crosses through the patient's body 29 on a desired axial direction 11, and produces the alignment of the catheter's tip 32 in the desired direction 11 to further allow the catheter's correct advancement. One of skill in the art will recognize that although some conventional magnetic fields have been employed to align catheters, none is so deep and directable as the FFMPT embodiments of the present disclosure. In these embodiments, the tip of the catheter accounts with diamagnetic or paramagnetic material 33 that allows the interaction of such catheter 30 with the far-field magnetic vector 11, thereby allowing the aiming of the tip 32 of the catheter 30 in the right direction. One of skill in the art will recognize that this technology may also be employed to move through the human or animal bodies, paramagnetic and diamagnetic materials, as for instance pharmacological compounds and cells containing such materials.

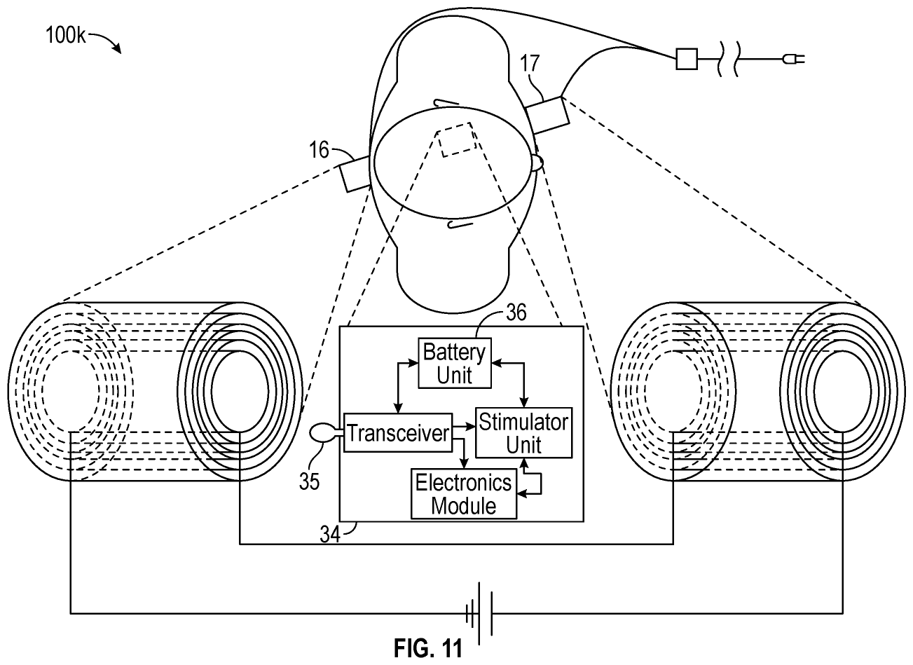

FIG. 11 is another embodiment of a far field magnetic power transfer (FFMPT) system and method 100k. FIG. 11 shows an embodiment for power transfer into an implantable medical device.

In the embodiment of FIG. 11, an FFMPT system and method is employed for power transfer to an electric circuit 34 without physically touching it. This system may in some cases send energy through matter toward an implanted electric device 35, where such device is located between such coupled array 16, 17 of multiple electromagnets. One of skill in the art will recognize that there are known ways to receive power from a magnetic source, and by applying these known principles, but without limiting the scope of this technology, the implanted electric device 35 is arranged with a receiver solenoid 35, which is appropriately located between the coupled arrays 16, 17 to transfer magnetic power to the battery 36 of such device. In this embodiment, an implantable medical system includes an external wireless charger 17 that itself includes the plurality of multi-solenoid arrays 16,17, a charger power supply 37, and a circuit 38 coupled between the charger power supply 37 and the inductive pair of multi coil arrays 16, 17 configured to drive the inductive coils so as to transmit magnetic power to an implantable power supply, and configured to detect and receive, via the inductive coil 35, power from an auxiliary charger for recharging of the charger power supply. One of skill in the art will recognize that the coupled multi solenoids arrays may also be arranged where the device's receiver coil 36 is coupled to an external array 16 and it is directly connected to the circuit of the device to be charged as shown on FIG. 11.

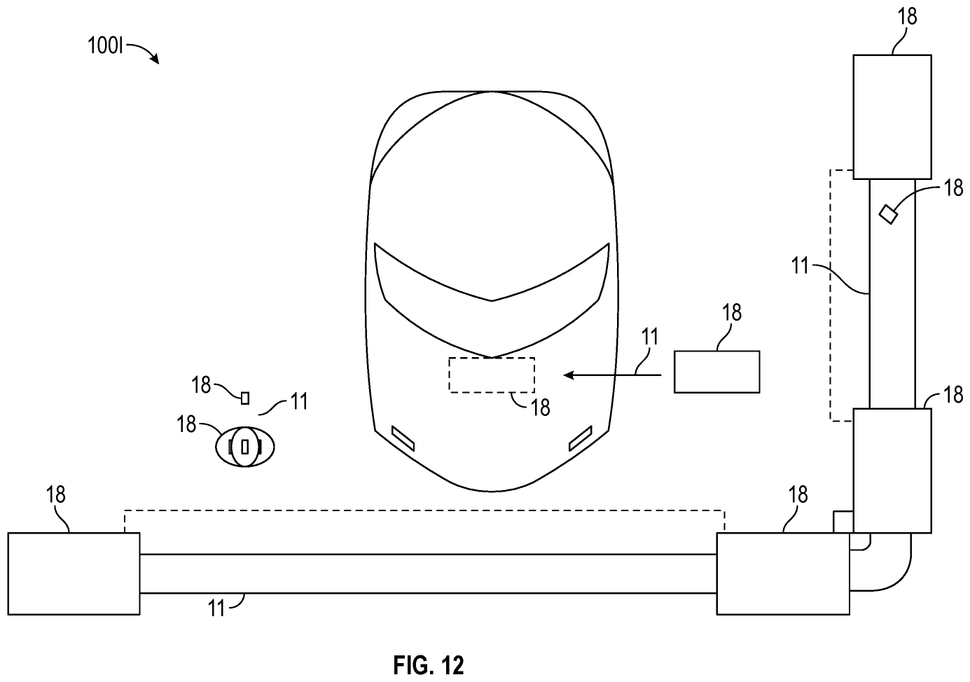

FIG. 12 is another embodiment of a far field magnetic power transfer (FFMPT) system and method 100l. FIG. 12 shows an embodiment arranged to sense the electromagnetic response of what is sensed with the far-field magnetic force (transfer equation).

The embodiment of FIG. 12 is arranged to transfer magnetic power to charge electrical devices and vehicles. This FFMPT may happen in various embodiments represented in FIG. 12. In one embodiment, for example, two arrays 18 of solenoids are coupled to transfer power between the emitter 16 and the receiver 17 where such energy is transferred to interact with whatever is between said coupled arrays 18. In this way, the system therefore may behave as a movement detector that triggers an alarm if some material alters its magnetic field. In other cases, this same or substantially similar embodiment may also applied when magnetic power transfer is desired and the receptor of such power is simply positioned in the trajectory of such main magnetic field 11 as shown in FIG. 12 where an electric device 39, such as smart device, is positioned. One of skill in the art will recognize that in some cases, improved results may be achieved when the device to receive the power has a receiving antenna that includes a multilayer solenoid array 18 as described in the present disclosure to better acquire the magnetic power by coupling with the emitter antenna 16. Some other examples to demonstrate that any electrical device with a receiver antenna may receive magnetic power transfer are an electric vehicle and a robot as well as a person with an electrical implant if positioned along the trajectory of the magnetic field 11. Another means of receiving magnetic power transfer includes a simple coupling between the emitter 16 and the receiver 17 where such receiver is part of the electric device. Thus, only an emitter 16 coupled to a receiver 17 solenoids array 18 are needed. One of skill in the art will recognize that the magnetic power transfer coupling not only may involve same frequency but low impedance, multi-layering, and similar structural features for acceptably optimal magnetic power transfer. One of skill in the art will further recognize that, this FFMPT teaching may also be employed for data transfer through the magnetic field emitted. Thus, a reduced amount of electromagnetic radiation that is constantly emitted and radiated by routers connected to modems at home or office on the radial and microwave spectrum may be realized. That is, by employing this magnetic power transfer as signal data transmission, ionizing radiation may be avoided and instead exchanged for magnetic power transfer that has been demonstrated to be harmless for living organisms. Accordingly, the embodiment of FIG. 12 may be applied to any number of electric devices, smart devices, robots, electric vehicles, implants, and the like, and these devices may be further arranged for communications (e.g., internet), as well as other digital data networks access through said magnetic field. This communication is possible by providing and deploying a receiving/emitter antenna and a decoding receiving emitter circuit that is arranged to work with radial to microwave data transmission as well as with a high frequency variable magnetic field. Given that smart devices connect to the router directly, not the modem, the router is responsible for establishing a local area network for all of the devices to communicate with each other. The modem's purpose is to connect the local area network to a wide area network such as the internet. Although there are known wireless data transfer protocols (e.g., WiFi, BLE, LoRa radio, and others), these protocols all use radio or microwave waves as the physical layer medium. Until now, there has been no fast, efficient way to transmit data using a magnetic field. Usually, to generate the lowest magnetic field power (mTesla) that sensors can currently detect, it should require significant amount of current in the electromagnet, which makes magnetic data non-practical with conventional technology. Besides, magnets usually have problems turning on and off at high frequencies. Having this in mind, given that the FFMPT systems and methods taught herein involve a low impedance, this innovation employs such feature to reduce the amount of energy required to produce enough Teslas by using such multilayer solenoids array 18 as taught in the present disclosure. Further, in order to transmit an acceptably optimal amount of digital data, at least one embodiment of the FFMPT mechanism includes emitter solenoid 6, 8 that is fed independently in a synchronized and consecutive fashion. In other words, the high frequency data is sequentially divided in small segments, and the segments are sequentially sent to the plurality of layers (e.g., A or B or C or D or E or For G in case this were a 7-layer solenoid) where other segments not transmitting the data in that particular segment remain fed with ridge or constant voltage. In this way, each individual solenoid will have more time to transduce electric signal into a magnetic field variation. This embodiment allows much more data transmission without high voltage or heavy energy losses than conventionally known magnetic data transfer systems. Hence, the advantages in some embodiments include that electromagnetic radiation may be mostly banned from home and office if a router is employed that interacts magnetically with them, switching to radial only if needed on high demand rare moments along the day.

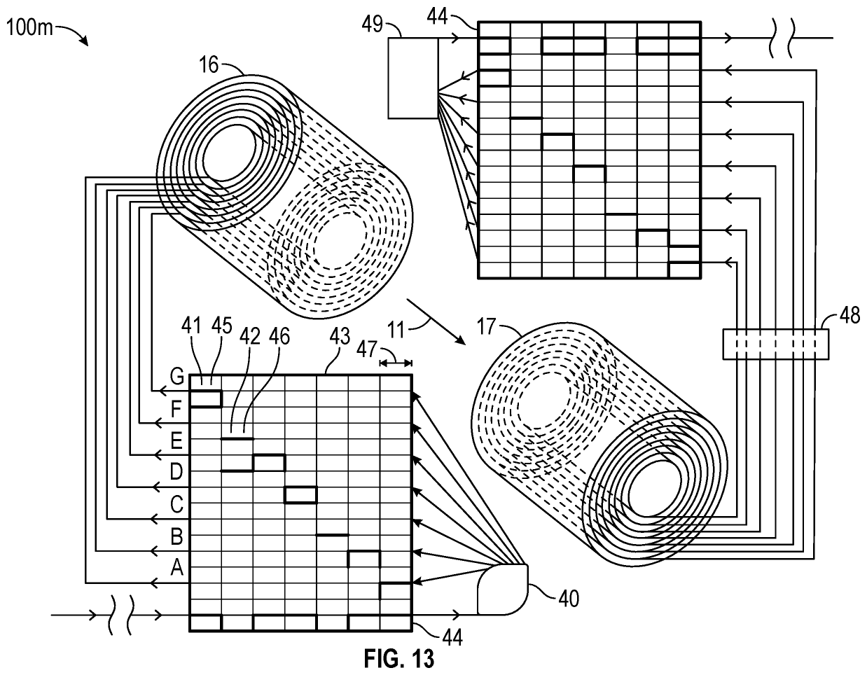

FIG. 13 is another embodiment of a far field magnetic power transfer (FFMPT) system and method 100m. In the embodiment of FIG. 13, digital data arrives to a router 40 where seven binary digits, each being a “one” 41 or “zero” 42 are represented on the graph 43 as a seven digits sequence 44 as 1011011. In this embodiment, the higher voltage 45 represents a “one” 41 and a lower voltage 46 represents a “zero” 42. One of skill in the art will recognize that each sequence is separated by standard electronic means into single 47 digits that are sequentially sent to layers A, B, C, D, E, F, G respectively by the router 40. By acting in such structures and in accordance with the teaching herein, such manner allows each solenoid 6, 8 to turn on and off only once every seven binary digits because we have, on this preferred embodiment, seven layers, lowering energy requirements and heat emission. The receiving solenoids array 17 on the receiving devices are now capable to figure out if a “zero” or a “one” was emitted and received through such magnetic field 11, recovering the exact binary number sequence 44 emitted by the router 40. One of skill in the art will further recognize that magnetic interference may be filtered with this novel far field data transfer magnetic system 45, given that, since each binary digit with value “one” was transmitted through an expected designed solenoid layer, that affects the magnetic field 11 on a very specific and unique manner. Hence, the filter verification parameters unit 48 may be programmed to clean the transmitted data by not admitting “ones” that did not came through the expected emitter layer at a particular time before turning it to the receiver device (49) electronic circuits.

Having now set forth certain embodiments, further clarification of certain terms used herein may be helpful to providing a more complete understanding of that which is considered inventive in the present disclosure.

In the embodiments of present disclosure, one or more particular components and devices of the embodiments are interchangeably described herein as “coupled,” “connected,” “attached,” and the like. It is recognized that once assembled, the system is suitably connected, sealed, and otherwise formed to a mechanically, medically, or otherwise industrially acceptable level.

The figures in the present disclosure lend themselves to one or more non-limiting computing device embodiments that control the operation and parameters of electromagnets. The computing devices may include operative hardware found in conventional computing device apparatuses such as one or more processors, volatile and non-volatile memory, serial and parallel input/output (I/O) circuitry compliant with various standards and protocols, wired and/or wireless networking circuitry (e.g., a communications transceiver), one or more user interface (UI) modules, logic, and other electronic circuitry.

To the extent that such computing devices include processing devices, or “processors,” these processors include central processing units (CPU's), microcontrollers (MCU), digital signal processors (DSP), application specific integrated circuits (ASIC), peripheral interface controllers (PIC), state machines, and the like. Accordingly, a processor as described herein includes any device, system, or part thereof that controls at least one operation, and such a device may be implemented in hardware, firmware, or software, or some combination of at least two of the same. The functionality associated with any particular processor may be centralized or distributed, whether locally or remotely. Processors may interchangeably refer to any type of electronic control circuitry configured to execute programmed software instructions. The programmed instructions may be high-level software instructions, compiled software instructions, assembly-language software instructions, object code, binary code, micro-code, or the like. The programmed instructions may reside in internal or external memory or may be hard-coded as a state machine or set of control signals. According to methods and devices referenced herein, one or more embodiments describe software executable by the processor, which when executed, carries out one or more of the method acts.

The embodiments of the present disclosure lend themselves to include or otherwise cooperate with one or more computing devices. It is recognized that these computing devices are arranged to perform one or more algorithms to implement various concepts taught herein. Each of said algorithms is understood to be a finite sequence of steps for solving a logical or mathematical problem or performing a task. Any or all of the algorithms taught in the present disclosure may be demonstrated by formulas, flow charts, data flow diagrams, narratives in the specification, and other such means as evident in the present disclosure. Along these lines, the structures to carry out the algorithms disclosed herein include at least one processing device executing at least one software instruction retrieved from at least one memory device. The structures may, as the case may be, further include suitable input circuits known to one of skill in the art (e.g., keyboards, buttons, memory devices, communication circuits, touch screen inputs, and any other integrated and peripheral circuit inputs (e.g., accelerometers, thermometers, light detection circuits and other such sensors)), suitable output circuits known to one of skill in the art (e.g., displays, light sources, audio devices, tactile devices, control signals, switches, relays, and the like), and any additional circuits or other structures taught in the present disclosure. To this end, every invocation of means or step plus function elements in any of the claims, if so desired, will be expressly recited.

As known by one skilled in the art, a computing device has one or more memories, and each memory comprises any combination of volatile and non-volatile computer-readable media for reading and writing. Volatile computer-readable media includes, for example, random access memory (RAM). Non-volatile computer-readable media includes, for example, read only memory (ROM), magnetic media such as a hard-disk, an optical disk, a flash memory device, a CD-ROM, and/or the like. In some cases, a particular memory is separated virtually or physically into separate areas, such as a first memory, a second memory, a third memory, etc. In these cases, it is understood that the different divisions of memory may be in different devices or embodied in a single memory. The memory in some cases is a non-transitory computer medium configured to store software instructions arranged to be executed by a processor. Some or all of the stored contents of a memory may include software instructions executable by a processing device to carry out one or more particular acts.

The computing devices described herein may further include operative software found in a conventional computing device such as an operating system or task loop, software drivers to direct operations through I/O circuitry, networking circuitry, and other peripheral component circuitry. In addition, the computing devices may include operative application software such as network software for communicating with other computing devices, database software for building and maintaining databases, and task management software where appropriate for distributing the communication and/or operational workload amongst various processors. In some cases, the computing device is a single hardware machine having at least some of the hardware and software listed herein, and in other cases, the computing device is a networked collection of hardware and software machines working together in a server farm to execute the functions of one or more embodiments described herein. Some aspects of the conventional hardware and software of the computing device are not shown in the figures for simplicity.

Amongst other things, exemplary computing devices of the present disclosure may be configured in any type of mobile or stationary computing device such as a remote cloud computer, a computing server, a smartphone, a tablet, a laptop computer, a wearable device (e.g., eyeglasses, jacket, shirt, pants, socks, shoes, other clothing, hat, helmet, other headwear, wristwatch, bracelet, pendant, other jewelry), vehicle-mounted device (e.g., train, plane, helicopter, unmanned aerial vehicle, unmanned underwater vehicle, unmanned land-based vehicle, automobile, motorcycle, bicycle, scooter, hover-board, other personal or commercial transportation device), industrial device (e.g., factory robotic device, home-use robotic device, retail robotic device, office-environment robotic device), or the like. Accordingly, the computing devices include other components and circuitry that is not illustrated, such as, for example, a display, a network interface, memory, one or more central processors, camera interfaces, audio interfaces, and other input/output interfaces. In some cases, the exemplary computing devices may also be configured in a different type of low-power device such as a mounted video camera, an Internet-of-Things (IOT) device, a multimedia device, a motion detection device, an intruder detection device, a security device, a crowd monitoring device, or some other device.

When so arranged as described herein, each computing device may be transformed from a generic and unspecific computing device to a combination device arranged comprising hardware and software configured for a specific and particular purpose such as to provide a determined technical solution. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

Software may include a fully executable software program, a simple configuration data file, a link to additional directions, or any combination of known software types. When a computing device updates software, the update may be small or large. For example, in some cases, a computing device downloads a small configuration data file to as part of a software update, and in other cases, a computing device completely replaces most or all of the present software on itself or another computing device with a fresh version. In some cases, software, data, or software and data is encrypted, encoded, and/or otherwise compressed for reasons that include security, privacy, data transfer speed, data cost, or the like.

Database structures, if any are present in the systems described herein, may be formed in a single database or multiple databases. In some cases, hardware or software storage repositories are shared amongst various functions of the particular system or systems to which they are associated. A database may be formed as part of a local system or local area network. Alternatively, or in addition, a database may be formed remotely, such as within a distributed “cloud” computing system, which would be accessible via a wide area network or some other network.

Input/output (I/O) circuitry and user interface (UI) modules include serial ports, parallel ports, universal serial bus (USB) ports, IEEE 802.11 transceivers and other transceivers compliant with protocols administered by one or more standard-setting bodies, displays, projectors, printers, keyboards, computer mice, microphones, micro-electro-mechanical (MEMS) devices such as accelerometers, and the like.

In at least one embodiment, devices as discussed herein may communicate with other devices via communication over a network. The network may involve an Internet connection or some other type of local area network (LAN) or wide area network (WAN). Non-limiting examples of structures that enable or form parts of a network include, but are not limited to, an Ethernet, twisted pair Ethernet, digital subscriber loop (DSL) devices, wireless LAN, Wi-Fi, Worldwide Interoperability for Microwave Access (WiMax), or the like.

In the present disclosure, memory may be used in one configuration or another. The memory may be configured to store data. In the alternative or in addition, the memory may be a non-transitory computer readable medium (CRM). The CRM is configured to store computing instructions executable by a processor. The computing instructions may be stored individually or as groups of instructions in files. The files may include functions, services, libraries, and the like. The files may include one or more computer programs or may be part of a larger computer program. Alternatively, or in addition, each file may include data or other computational support material useful to carry out the computing functions of a system described in the present disclosure.

Buttons, keypads, computer mice, memory cards, serial ports, bio-sensor readers, touch screens, and the like may individually or in cooperation be useful to a user operating the far field magnetic power transfer (FFMPT) devices described herein. The devices may, for example, input control information into the system. Displays, printers, memory cards, LED indicators, temperature sensors, audio devices (e.g., speakers, piezo device, etc.), vibrators, and the like are all useful to present output information to the user operating the described systems. In some cases, the input and output devices are directly coupled to the FFMPT system and electronically coupled to a processor or other operative circuitry. In other cases, the input and output devices pass information via one or more communication ports (e.g., RS-232, RS-485, infrared, USB, etc.).

As described herein, for simplicity, a medical practitioner or other use may in some cases be described in the context of the male gender. It is understood that a medical practitioner or other user can be of any gender, and the terms “he,” “his,” and the like as used herein are to be interpreted broadly inclusive of all known gender definitions. As the context may require in this disclosure, except as the context may dictate otherwise, the singular shall mean the plural and vice versa; all pronouns shall mean and include the person, entity, firm or corporation to which they relate; and the masculine shall mean the feminine and vice versa.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a first electromagnetic array 102 may be described as being formed or otherwise oriented “substantially along a common axis.” In these cases, an axis that is oriented exactly vertical is oriented along a “Z” axis that is normal (i.e., 90 degrees or at right angle) to a plane formed by an “X” axis and a “Y” axis. Different from the exact precision of the term, “vertical,” the use of “substantially” to modify the characteristic permits a variance of the “vertical” characteristic by up to 30 percent. Accordingly, an axis that is oriented “substantially vertical” includes axes oriented between 63 degrees and 117 degrees. An axis that is oriented at 45 degrees of an X-Y plane, however, is not oriented “substantially vertical.” As another example, a solenoid 116 having a particular linear dimension of “between about three (3) inches and five (5) inches” includes such devices in which the linear dimension varies by up to 30 percent, Accordingly, the particular linear dimension of the solenoid 116 may be between one point five (1.5) inches and six point five (6.5) inches.

Where a range of values is provided, it is understood that each intervening value, to the tenth of the unit of the lower limit unless the context clearly dictates otherwise, between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either or both of those included limits are also included in the invention.

Unless defined otherwise, the technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein.

In the present disclosure, when an element (e.g., component, circuit, device, apparatus, structure, layer, material, or the like) is referred to as being “on,” “coupled to,” or “connected to” another element, the elements can be directly on, directly coupled to, or directly connected to each other, or intervening elements may be present. In contrast, when an element is referred to as being “directly on,” “directly coupled to,” or “directly connected to” another element, there are no intervening elements present.

The terms “include” and “comprise,” as well as derivatives and variations thereof, in all of their syntactic contexts, are to be construed without limitation in an open, inclusive sense, (e.g., “including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Reference throughout this specification to “one embodiment” or “an embodiment” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the present disclosure, the terms first, second, etc., may be used to describe various elements, however, these elements are not to be limited by these terms unless the context clearly requires such limitation. These terms are only used to distinguish one element from another. For example, a first machine could be termed a second machine, and, similarly, a second machine could be termed a first machine, without departing from the scope of the inventive concept.

The singular forms of “a,” “an,” and “the” in the present disclosure include plural referents unless the content and context clearly dictates otherwise. The conjunctive terms, “and” and “or,” are generally employed in the broadest sense to include “and/or” unless the content and context clearly dictates inclusivity or exclusivity as the case may be. The composition of “and” and “or” when recited herein as “and/or” encompasses an embodiment that includes all of the elements associated thereto and at least one more alternative embodiment that includes fewer than all of the elements associated thereto.

In the present disclosure, conjunctive lists make use of a comma, which may be known as an Oxford comma, a Harvard comma, a serial comma, or another like term. Such lists are intended to connect words, clauses, or sentences such that the thing following the comma is also included in the list.

The headings and Abstract of the Disclosure provided herein are for convenience only and do not interpret the scope or meaning of the embodiments.

The various embodiments described above can be combined to provide further embodiments. Various features of the embodiments are optional, and features of one embodiment may be suitably combined with other embodiments. Aspects of the embodiments can be modified, if necessary, to employ concepts of the various patents, application and publications to provide yet further embodiments.
Example 1 is a far field magnetic power transfer (FFMPT) system and method comprised by a multi magnet of multiple layers array.
Example 2 is an example in concordance with Example 1 or with Example 1 and any one or more other Examples disclosed herein where an FFMPT system and method is comprised by multi electromagnet of multiple layers array.
Example 3 is an example in concordance with Example 1 or with Example 1 and any one or more other Examples disclosed herein where an FFMPT system and method includes at least two multi electromagnet arrays where each electromagnet receives its own electric current and therefore produces its own magnetic field, being the magnetic forces of the magnetic fields of each electromagnet, aligned in a determined direction such as substantially parallel, with the tendency of being aligned to each other, given that the electromagnets belonging to the same group are built with the substantially the same shape but with different size in order to behave as a multi electromagnet of multiple layers array.
Example 4 is an example in concordance with Example 1 or with Example 1 and any one or more other Examples disclosed herein where the magnets are built in a substantially tubular fashion where such multiple magnets are electrically connected in parallel in some cases, electrically connected in serial in some cases, or electrically connected partially in parallel and partially in serial in some cases.
Example 5 is an example in concordance with Example 1 or with Example 1 and any one or more other Examples disclosed herein where the interaction of such multiple magnetic fields in a given period of time generates asynchronous as well as synchronous magnetic field.
Example 6 is an example in concordance with Example 1 or with Example 1 and any one or more other Examples disclosed herein where a resonant magnetic field may be produced.
Example 7 is an example in concordance with Example 1 or with Example 1 and any one or more other Examples disclosed herein where each magnet may be sourced independently with variable intensities, voltages, frequencies, waveforms, or other parameters to generate a multivariate multi region magnetic field.
Example 8 is an example in concordance Example 1 or with Example 1 and any one or more other Examples disclosed herein where the core of the solenoids is selected from one or more of a high magnetic permittivity material such as iron, Permalloy (nickel-iron), Mu-material (Nickel-Iron-Zinc), or a vacuum to increase magnetic power transfer.
Example 9 is an example in concordance with Example 1 or with Example 1 and any one or more other Examples disclosed herein where multilayer solenoids arrays may be employed as the substitute of standard solenoids in order to increase inductive power and inductive length reach and to decrease impedance.
Example 10 is an example in concordance with Example 1 or with Example 1 and any one or more other Examples disclosed herein where this FFMPT system is employed for charging of electric devices by placing such devices between at least a couple of multilayer electromagnets array, having such electric device a receiving charging electromagnet and the electronic means to use it.
Example 11 is an example in concordance with Example 1 or with Example 1 and any one or more other Examples disclosed herein where this FFMPT system is employed for charging electric devices by electrically coupling a multilayer electromagnet to the device to be charged via the emitter multiple solenoids array and the multiple solenoids array connected to the device to be charged
Example 12 is an example in concordance with Example 1 or with Example 1 and any one or more other Examples disclosed herein where this FFMPT system is employed as data transfer technology between coupled multilayer solenoids arrays by changes on the magnetic field, in order to use such magnetic field intensity variations as binary digital code.
Example 13 is an example in concordance with Example 1 or with Example 1 and any one or more other Examples disclosed herein where this FFMPT system is employed as data transfer technology between multilayer solenoids arrays and a third emitter and receiver multiple solenoids array that is connected to a smart device such as a smart phone, a tablet, an implantable device, or a vehicle, in order to receive or emit binary data and as long as such third solenoids array remains on the transmission range of such first and second coupled solenoids array.
Example 14 is an example in concordance with Example 1 or with Example 1 and any one or more other Examples disclosed herein where this FFMPT system is employed as data transfer technology between at least one router connected multilayer solenoids array and a third emitter and receiver multiple solenoids array that is connected to a smart device such as a smart phone, a tablet, an implantable device, or a vehicle, in order to directly couple the router with the device and receive or emit binary data and as long as such third solenoids array (i.e., as long as the devices are communicatively connected) remains on the transmission range of such first solenoids array.
Example 15 is an example in concordance with Example 1 or with Example 1 and any one or more other Examples disclosed herein wherein each emitter solenoid in this FFMPT system is fed independently in a synchronized and consecutive fashion where the high frequency data is sequentially divided in small segments and sequentially are sent to consecutive layers where the other segments not transmitting the data in that particular segment, remain fed with ridge or constant voltage, thereby permitting each individual solenoid to have more time to transduce electric signals into a magnetic field variation, such embodiments allowing much more data transmission without high voltage or heavy energy losses.
Example 16 is an example in concordance with Example 1 or with Example 1 and any one or more other Examples disclosed herein wherein digital data in this FFMPT system arrives to the router where binary digits, comprised each by “one” or “zero”, where the higher voltage represents the number “one” and lower voltage represents “zero,” where each sequence is separated by electronic means into single digits that are sequentially sent to the emitter layers respectively by the router to each solenoid to turn on and off only once every seven binary digits, lowering energy requirements and heat emission, the receiving solenoids array on the receiving devices now being capable of determining if a “zero” or a “one” was emitted and received through such magnetic field, recovering the exact binary number sequence emitted by the router where interference may be filtered with this data transfer magnetic system given that since each binary digit with value “one” was transmitted through a timed specific solenoid layer where the whole magnetic field was affected in a determined and certain manner every time a “one” passes through such layer; the verification parameters arranged to clean the transmitted data and not admit “ones” that did not come through the expected emitter layer at such specific particular time.
Example 17 is an example in concordance with Example 1 or with Example 1 and any one or more other Examples disclosed herein where this FFMPT system is employed as data transducer technology between the coupled system and the electric system located between such coupled system.

U.S. Provisional Patent Application No. 63/387,693, filed Dec. 15, 2022, is incorporated herein by reference, in its entirety.

In the description herein, specific details are set forth in order to provide a thorough understanding of the various example embodiments. It should be appreciated that various modifications to the embodiments will be readily apparent to those skilled in the art, and the generic principles defined herein may be applied to other embodiments and applications without departing from the spirit and scope of the disclosure. Moreover, in the following description, numerous details are set forth for the purpose of explanation. However, one of ordinary skill in the art should understand that embodiments may be practiced without the use of these specific details. In other instances, well-known structures and processes are not shown or described in order to avoid obscuring the description with unnecessary detail. Thus, the present disclosure is not intended to be limited to the embodiments shown but is instead to be accorded the widest scope consistent with the principles and features disclosed herein. Hence, these and other changes can be made to the embodiments in light of the above-detailed description. In general, in the following claims, the terms used should not be construed to limit the claims to the specific embodiments disclosed in the specification but should be construed to include all possible embodiments along with the full scope of equivalents to which such claims are entitled. Accordingly, the claims are not limited by the disclosure.

1. A Far Field Magnetic Power Transfer System comprising a multi magnet of multiple layers array.

2. The Far Field Magnetic Power Transfer System of claim 1, wherein the a multi magnet of multiple layers array is a multi electromagnet of multiple layers array.

3. The Far Field Magnetic Power Transfer System of claim 1, wherein the multi magnet of multiple layers array further comprises at least two multi electromagnet arrays, wherein each electromagnet receives its own electric current and therefore produces its own magnetic field, being the magnetic forces of the magnetic fields of each paralleled electromagnet with the tendency of being aligned to each other, given that the electromagnets belonging to the same group are built with the same shape but with different size in order to behave as a multi electromagnet of multiple layers array.

4. The Far Field Magnetic Power Transfer System of claim 3, wherein the electromagnets are built on a tubular fashion wherein such multiple magnets are connected in parallel.

5. The Far Field Magnetic Power Transfer System of claim 4, wherein the interaction of the multiple magnetic fields in a given period of time generates an asynchronous as well as synchronous magnetic field.

6. The Far Field Magnetic Power Transfer System of claim 5, wherein a Resonant Magnetic Field may be produced.

7. The Far Field Magnetic Power Transfer System of claim 6, wherein each magnet may be feed independently with variable intensities, voltages and frequencies in order to generate a multivariate multi region magnetic field.

8. The Far Field Magnetic Power Transfer System of claim 7, further comprising solenoids, and wherein a core of the solenoids comprises a high magnetic permittivity material such as iron, Permalloy (nickel-iron), Mu-material (Nickel-Iron-Zink) or vacuum in order to increase magnetic power transfer.

9. The Far Field Magnetic Power Transfer System of claim 1, further comprising multilayer solenoid arrays employed in order to increase inductive power and inductive length reach and to decrease impedance.

10. The Far Field Magnetic Power Transfer System of claim 1, wherein the Far Field Power Transfer is adapted for charging of electric devices by placing the electric devices between at least two of the multilayer electromagnets arrays, wherein the electric device includes a receiving charging electromagnet and the electronic means to use it.

11. The Far Field Magnetic Power Transfer System of claim 11, wherein the Far Field Power Transfer System is adapted for charging of electric devices by connecting a multilayer electromagnet to the device to be charged in order to directly couple the emitter multiple solenoids array with the multiple solenoids array connected to the device to be charged.

12. The Far Field Magnetic Power Transfer System of claim 11, wherein the Far Field Magnetic Power transfer system is adapted for use as a data transfer system between the coupled multilayer solenoids arrays by changes on the magnetic field, in order to use such magnetic field intensity variations as binary digital code.

13. The Far Field Magnetic Power Transfer System of claim 12, wherein the Far Field Magnetic Power transfer is adapted for us as a data transfer system between the multilayer solenoids arrays and a third emitter and receiver multiple solenoids array that is connected to a smart device such as a smart phone, a tablet, an implantable device or a vehicle, in order to receive or emit binary data and as long as such third solenoids array remains on the transmission range of such first and second coupled solenoids array.

14. The Far Field Magnetic Power Transfer System of claim 13, wherein the Far Field Magnetic Power transfer is adapted for use as a data transfer system between at least one router connected to multilayer solenoids arrays and a third emitter and receiver multiple solenoids array that is connected to a smart device such as a smart phone, a tablet, an implantable device or a vehicle, in order to directly couple the router with the device and receive or emit binary data and as long as the third solenoids array remains on the transmission range of such first solenoids array.

15. The Far Field Magnetic Power Transfer System of claim 14, wherein each emitter solenoid is feed independently in a synchronized and consecutive fashion wherein the high frequency data is sequentially divided in small segments and sequentially sent to consecutive layers where the other segments not transmitting the data in that particular segment, remain feed with ridge or constant voltage, whereby each individual solenoid will have more time to transduce electric signal into a magnetic field variation.

16. The Far Field Magnetic Power Transfer System of claim 15, wherein digital data arrives to the router where binary digits, comprised each by “one” or “zero”, where the higher voltage represents the number “one” and lower voltage represents “zero”, wherein each sequence is separated by standard electronic means into single digits that are sequentially sent to the emitter layers respectively by the router in order to each solenoid to turn on and off only once every seven binary digits, lowering energy requirements and heat emission, whereby, the receiving solenoids array on the receiving devices are capable to figure out if a “zero” or a “one” was emitted and received through such magnetic field, recovering the exact binary number sequence emitted by the router where interference may be filtered with this novel data transfer magnetic system given that since each binary digit with value “one” was transmitted through a timed specific solenoid layer where the whole magnetic field was affected on a very specific and unique manner every time a “one” passes through such layer, thereby the verification parameters to clean the transmitted data will not admit “ones” that did not come through the expected emitter layer at such specific particular time.
